(19) United States
(12) Patent Application Publication
(10) Pub. No.: US 2005/0177357 A1
(43) Pub. Date: Aug. 11, 2005

(54) Static timing model for combinatorial gates having clock signal input

(76) Inventors: Matthew J. Amatangelo, Austin, TX (US); Jeannette N. Sutherland, Cedar Park, TX (US); Robert E. Mains, Morgan Hill, CA (US)

Correspondence Address: Stephen A. Terrile;HAMILTON & TERRILE, LLP, PO Box 203518, Austin, TX, 78720, US

(21) Appl. No.: 10/774,990

(22) Filed: Feb. 9, 2004

(51) Int. Cl. G06F 17/50

(52) U.S. Cl. 703/16

(57) ABSTRACT

A method of modeling a combinatorial gate which includes providing a data signal input at the combinatorial gate, providing a clock signal input at the combinatorial gate, propagating the clock signal as an output signal when the output of the combinatorial gate corresponds to the clock signal, and propagating the data signal as an output when the output of the combinatorial gate corresponds to the data signal, the propagating the data signal modeling a near domino function.

### BACKGROUND OF THE INVENTION

1. Field of the Invention

The present invention relates to static timing analysis, and more particularly to static timing analysis for combinatorial gates.

2. Description of the Related Art

It is known to verify timing behavior using static timing analysis. Static timing analysis analyzes a circuit design for the earliest and latest possible signal arrival times on each logic path or node within the circuit design, regardless of what is happening on other paths within the circuit. The arrival times combined with the signal transition time (referred to as the slew) are expressed as time windows. Comparing the arrival times at a particular node (i.e., net) in the logic with a required arrival time provides the slack at that node in the logic. By assuming that the earliest and latest signals as expressed by the time window can be propagated through a particular gate, static timing analysis can be independent of the logic function of the gate.

One aspect of static timing analysis involves modeling the timing of elements within the circuit design. A static timing analyzer accesses circuit timing performance by relying upon timing attributes, as specified in a library of timing models, for individual circuit components in a netlist. The library of timing models includes timing information for each circuit component in the netlist. The timing information includes such information as the input pin capacitance, input-to-output delay, and output drive strengths. Combining this library along with a design netlist, a static timing analyzer generates critical path timing information statically without knowledge of the design's logical functionality.

Static timing analysis may be applied to a two input NAND circuit. Typically, cells such as the two input NAND circuit are stored in cell libraries and may be used as building blocks by designers to construct larger and more complex integrated circuits. Typically, for each cell in a cell library, a dynamic timing analysis has already been performed and the timing parameters of the cell are maintained as part of the cell description. In this example shown, the NAND circuit may be known to have a minimum delay of 30 picoseconds, and a maximum delay of 40 picoseconds, for a rising edge received at each of two inputs, A and B. Thus, if it is known that a rising edge will be received at input A at sometime between 10 and 20 picoseconds measured from an initial time p0, then the earliest output will be a falling edge at output C at 40 picoseconds and a latest falling edge at output C at 60 picoseconds from time p0. Since in any given cycle a data signal on input B can be either high or low, input B is ignored when computing the delay from input A to the output C. Thus, the timing computed for the circuit is described in terms of minimum and maximum signal switching times and is independent of the actual pattern received at the inputs.

When a gate level timer of a static timing engine encounters a standard logic block such as a NAND gate and all inputs are data signals, the gate level timer propagates the earliest and latest arrival time to the output of the block for that set of inputs and corresponding block delays. If the inputs to the logic block include a clock signal, then the gate level timer of the static timing engine considers the logic block as a gated clock and thus only the clock edges cause the output to switch state. However, sometimes it might be desirable to propagate the data signal instead of the clock signal. Propagating the data signal would cause a different set of event ordering checks to be performed within the static timing engine.

### SUMMARY OF THE INVENTION

In accordance with the present invention, a method for providing a static timing engine with an alternative to a gated clock check when a clocked combinatorial logic gate is analyzed is disclosed. Additionally, in accordance with another aspect of the invention, a method for use with static timing analysis for determining whether to model a combinatorial gate as a near-domino circuit block or a gated clock circuit block is disclosed.

In one embodiment, the invention relates to a method of modeling a combinatorial gate which includes providing a data signal input at the combinatorial gate, providing a clock signal input at the combinatorial gate, propagating the clock signal as an output signal when the output of the combinatorial gate corresponds to the clock signal, and propagating the data signal as an output when the output of the combinatorial gate corresponds to the data. The latter is the near domino function.

In another embodiment, the invention relates to a method of determining how to model a combinatorial gate where the combinatorial gate receives a data signal and a clock signal which includes performing a reverse traversal function on a circuit containing the combinatorial gate, modeling an output of the combinatorial gate as the clock signal when an input to a next element of the circuit is a clock, and modeling the output of the combinatorial gate as a data signal when an input to a next element of the circuit is a data signal.

In another embodiment, the invention relates to a method of modeling a combinatorial gate within a static timing analysis which includes receiving a data signal at the combinatorial gate, receiving a clock signal at the combinatorial gate, providing an output corresponding to the clock signal when the output of the combinatorial gate corresponds to the clock signal, and providing an output having a near domino function when the output of the combinatorial gate corresponds to the data signal.

In another embodiment, the invention relates to a static timing engine which includes a data model, a timing engine portion coupled to the data model. The data model includes a combinational block determinator module. The combinational block determinator module includes means for performing a reverse traversal function on a circuit containing the combinatorial gate. The timing engine portion includes means for modeling the combinatorial gate as a clock gate when subsequent circuitry deems that the output of this gate should be a clock, and means for modeling the combinatorial gate as a near domino gate when subsequent circuitry needs the output of this gate to be data.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a schematic block diagram of a static timing engine.

FIG. 2 shows a flow chart of a method for determining how to model a combinatorial gate.

FIG. 3 shows an example logic diagram of logic blocks of a circuit design on which a static timing analysis is performed.

FIG. 4 shows an example of signal propagation and checks for a portion of the logic blocks of the FIG. 3 logic diagram.

FIG. 5 shows another example of signal propagation through a portion of the logic blocks of the FIG. 3 logic diagram.

FIG. 6 shows another example logic diagram of logic blocks of a circuit design on which a static timing analysis is performed.

FIG. 7 shows another example logic diagram of logic blocks of a circuit design on which a static timing analysis is performed.

FIG. 8 shows a timing diagram of a master clock signal and two additional timing signals.

FIG. 9 shows a Table setting forth a variety of launch and capture situations for the circuit of FIG. 7.

FIG. 10 shows a timing diagram of a one launch and capture situation of the FIG. 9 Table.

### DETAILED DESCRIPTION

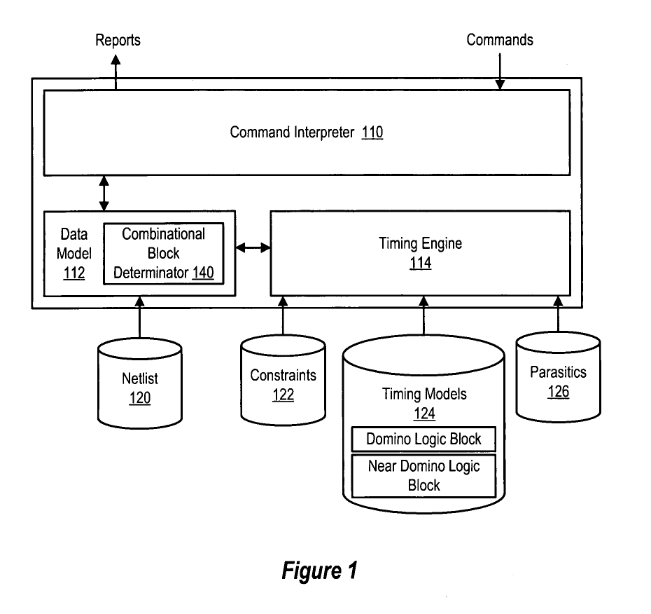

Referring to FIG. 1, a schematic block diagram of a static timing engine 100 is shown. The static timing engine 100 is a timing tool that performs static timing analysis of a circuit design. The static timing engine 100 includes a command interpreter 110, a data model 112 and a timing engine portion 114. The static timing engine 100 receives inputs from a netlist file 120, a constraints file 122, a timing model file 124 and a parasitics file 126. The data model 112 includes a combinatorial block determinator module 140. The timing analysis is performed based upon the inputs from the various files and reports showing the results of the timing analysis are provided as outputs. The command interpreter 110 receives commands from a user of the timing engine and provides reports to the user.

The netlist file 120 is a structural representation of a circuit design. The structural representation may be generated from a processed data model of the circuit design. In one embodiment, the netlist file 120 may be a Verilog netlist. The netlist may be hierarchical and may span multiple files.

The constraints file 122 enables a timing analysis to place various constraints that affect a circuit design timing on the circuit design. The constraints may model boundary conditions around the circuit design being timed or may constrain internal points within the circuit design.

The timing model file 124 provides the static timing engine with information regarding cell delay and slew characteristics. The cell time model is generated via a pre-characterization process. Each path (input port to output port) of a cell is simulated under a variety of input transition times and output loads and the results are provided as the cell delay and slew characteristics of a cell. The timing model file also includes setup and hold constraints for a particular cell which define the earliest and latest times that a signal can arrive at a cell relative to another signal. The timing model also includes constraints on the slew and load capacitance for each port of a cell. Additionally, the timing model file includes timing models for a domino logic block 150 and a near domino block 152.

The parasitics file 126 includes parasitics information that is provided to the static timing engine 100. The parasitics information includes transfer functions for determining net delays from pin to pin and a realizable driving point PI model for computing drive capacitance values for pins.

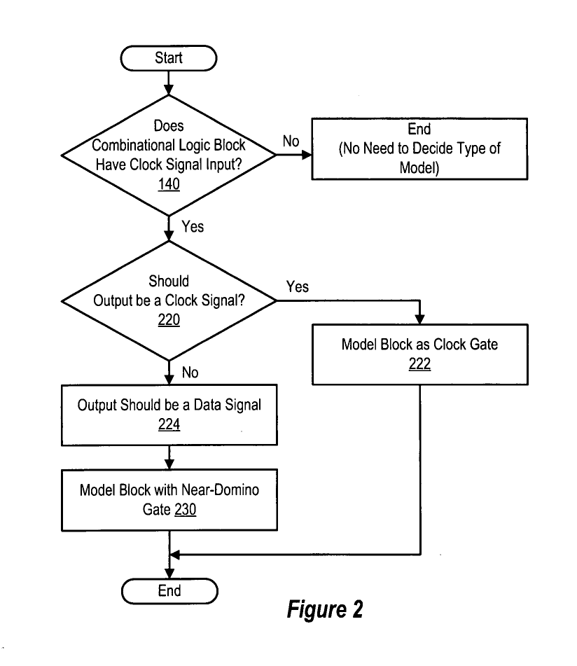

Referring to FIG. 2, a flow chart of a method for determining how to model a combinatorial gate is shown. The combinatorial block determinator module 140 determines whether to model a combinatorial logic block as a clock gate or as a near domino gate. A clock gate model receives a data signal and a clock signal as inputs and provides a clock signal output. A near domino gate receives a data signal and a clock signal as inputs and provides a data signal as an output.

More specifically, the combinatorial block determinator module 140 starts operation by determining whether the combinatorial logic block receives a clock signal as one of its input signals at step 210. If the combinatorial logic block does not receive a clock signal as an input signal, then the combinatorial logic block is modeled as a standard combinatorial logic block. In a standard combinatorial logic block model, input data propagates to output data with no event order checks being performed on the data.

If the combinatorial logic block receives a clock signal as an input signal, then the combinatorial block determinator module 140 determines whether the output of the combinatorial block should be a clock signal at step 220. If the output of the combinatorial block should be a clock signal, then the combinatorial block determinator module 140 models the block as a clock gate at step 222 and the operation of the combinatorial block determinator module 140 completes.

If the output of the combinatorial block should not be a clock signal, then the output of the combinatorial block should be a “data” signal and the combinatorial block determinator module 140 models the block as a near domino gate at step 230. The operation of the combinatorial block determinator module 140 then completes.

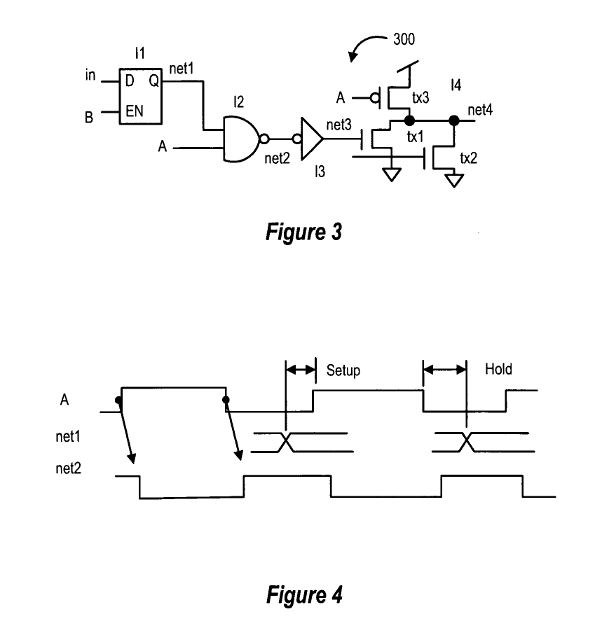

Referring to FIG. 3, an example logic diagram of logic blocks of a circuit 300 on which a static timing analysis is performed is shown. More specifically, an example logic diagram includes a plurality of logic blocks such as latch I1, NAND gate I2, inverter I3 and a footless domino circuit I4. The logic block I1 receives an input signal “in” and an enable signal “B” and provides an output signal “net1”. The signal “net1” is provided to NAND gate 12, which also receives an input clock signal “A”. The NAND gate I2 provides an output signal “net2” to inverter I3. Inverter I3 provides an output signal “net3” to the domino circuit I4. The domino circuit I4 receives the “net3” signal as well as the clock signal “A” and provides an output signal “net4”.

The circuit 300 shows the clock-data convergent block (I2) taking clock input signal “A” and data input “net1” and generating output “net2.” Then “net2” propagates through an inverter and into evaluation transistor “tx1” of the footless domino circuit I4 which is reset by clock signal “A.”

During an exemplative static timing analysis, it is desired that the input to the domino circuit on “net3” be a data signal. It is also desired that the data arrival of “net1” be checked against the falling edge of clock “A” as opposed to the asserting edge of the clock signal “A”. This analysis might be where a designer is using the NAND gate I2 as a signal conditioner and feeding the output signal net2 to the footless dynamic circuit I4.

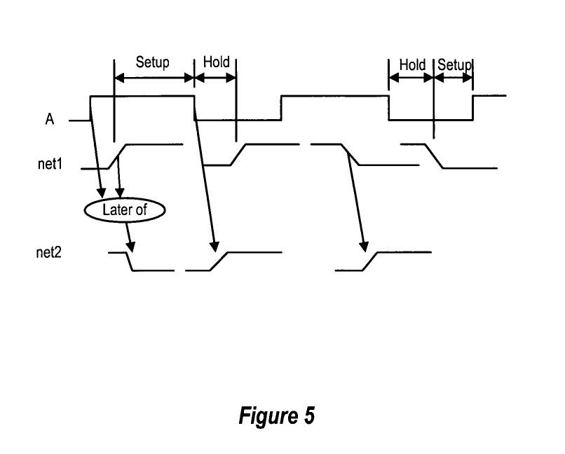

The design choice of using a footless domino circuit (as compared to a footed domino circuit) may be made based upon a number of factors. For example, FIG. 4 shows an example a gated clock check which requires that the data be setup prior to the arrival of the clock's asserting edge so that the clock signal propagates fully and glitch-free; there is no transparency allowed in a gated clock check. FIG. 5 shows the transparent nature of a near domino model where “net1” is allowed to rise after clock “A” has asserted high, thus avoiding the more pessimistic setup requirement of a gated clock check model.

More specifically, FIG. 5 shows an example timing diagram of a method for modeling a combinatorial gate which receives a clock signal and a data signal. In the circuit shown in FIG. 3, clock propagation is blocked by gate “I2.” The output signal “net2” is a dynamic signal and, like a clock signal, includes two edges per cycle, a data edge and a reset edge. The output signal “net2” does not represent a domino type arrangement because the propagation of “net1” falling to “net2” rising does not correspond to the function if the gate were operating as a domino gate.

More specifically, the later arriving positive edge signal between the “A” signal and the “net1” signal causes the output signal “net2” to respond. The function of the NAND gate I2 determines this operation. Unlike domino operation, any time the “net1 ” data signal falls, if the output is not already high, causes to transition high. The waveforms of FIG. 5 can be adjusted to accommodate both NAND and NOR logic blocks.

Thus, for a NAND gate, the later of a clock signal rising and a data signal rising causes the output data leading edge to propagate. The phase of the gate output propagating the data leading edge is related to the clock signal rising edge. When the cause of the output data reset edge to propagate is a falling clock signal, then the phase of the gate output propagating the data signal reset edge is related to the clock signal's falling edge. When the cause of the output data reset edge to propagate is a falling data signal, then the phase of the gate output propagating the data signal reset edge is related to the clock that generated the data signal input's falling edge.

For a NOR gate, the later of a clock signal falling and a data signal falling causes the output data leading edge to propagate. The phase of the gate output propagating the data leading edge is related to the clock signal falling edge. When the cause of the output data reset edge to propagate is a rising clock signal, then the phase of the gate output propagating the data signal reset edge is related to the clock signal's rising edge. When the cause of the output data reset edge to propagate is a rising data signal, then the phase of the gate output propagating the data signal reset edge is related to the clock that generated the data signal input's rising edge.

Referring again to FIG. 1, the static timing engine 100 performs timing checks based upon the type of element. The type of element include a latch (the checks performed on a flip flow are the same as those performed on a latch), a clock gate, or a domino gate (footed and footless). When a clock signal meets a data signal at a logic block, the logic block is considered as one of these types of elements. Of these types of elements, only the clock gate propagates the signal as a clock type signal. (It is important for a user to know that a signal is propagated as a clock signal when considering clock tree propagation.) The other types of elements, a latch and a domino gate, propagate the resultant signal as data signal.

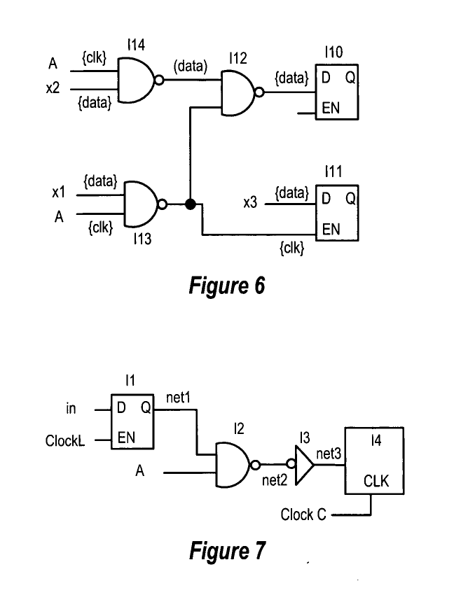

The checks associated with the types of element may have a profound affect on how the operation of a circuit design is considered. For instance, a latch does not have the notion of a “reset data edge” as does the domino gate. Assuming the timer determines the output of the logic block is not a clock, if the timer is to discriminate between whether the block ought to be treated as a latch or domino circuit, some other information must be considered. For example, in one embodiment, a keyword (e.g., the keyword “latch”) is associated with a logic block whenever a latch is present. If the keyword is absent from the model, then the static timing engine 100 is enabled to perform near-domino checks and propagations such as those set forth in FIG. 6.

The static timing engine 100 determines whether the output of a combinatorial logic block having clock and data inputs is a data phase by reverse traversal of the path through all combinatorial blocks from all other instances where clock and data typing are definitive. For example, FIG. 6 shows a clock signal “A” entering logic blocks I13 and I14 with data signals “x1” and “x2,” respectively. The labels for “clock” and “data” types are in braces for these inputs to indicate that this identification of these signals as clock and data signals was established prior to the application of a reverse traversal procedure on this circuit. The latches I10 and I11 have deterministic inputs as well. Because elements I10 and I11 are latches, their input pin types (i.e., whether an input should be a data input or a clock input) govern how the static timing engine performs clock propagation for the element. For example, the EN input of element I11 must be a clock input and the D input of I10 must be data (as indicated by the braces). The only undefined signal type is that of the output of combinatorial logic gate I14. By reverse traversal, the static timing engine 100 determines this output to be data. Because this output signal is a determinative signal (i.e., a signal whose signal type is determined by the reverse traversal function), the output signal of combinatorial logic gate I14 is surrounded by parentheses as opposed to the braces.

More specifically, the reverse traversal function is performed as follows: the data input of latch I10 forces the output of I12 to be data. The clock or enable input of I11 forces the output signal of combinatorial logic block I13 to be a clock signal. Hence combinatorial logic gates I12 and I14 are treated as near-domino circuits and combinatorial logic gate I13 is treated as a clock gate.

The circuit set forth in FIG. 7 is another example logic diagram of logic blocks of a circuit design on which a static timing analysis is performed. This circuit design helps to illustrate other scenarios that a designer might try and thus to show that the gate timer alternative for handling a clock data convergent blocks has merit. More specifically, the design shown in FIG. 7 corresponds to the design shown in FIG. 3 with a few changes. For example, the element “I4” represents any possible timing element (such as a gated clock gate, a near domino gate, or a latch) that could be used to capture the signal “net3.” Also, the latch I1 which launches the output signal “net1” now has a launch clock signal “ClockL.” Also, the latch “I4” receives a capture clock signal “ClockC.”

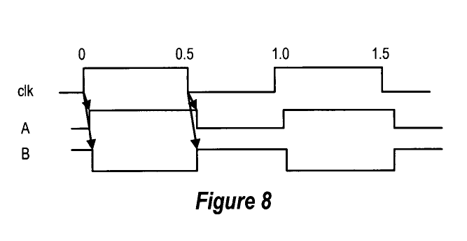

Because the alternative clock gating method of FIG. 2 allows data to propagate through “I2”, the phase of that data will be important to the capturing mechanism of “I4”. Accordingly, all combinations of phase launches and captures should be investigated. It is assumed that all clocks are synchronous to some master clock and hence all data are essentially launched and captured with reference to either the rising or falling edge of the master clock. FIG. 8 shows this master reference clock “clk” relevant to the typically named phases “A” and “B”.

By analyzing the circuit design set forth in FIG. 7, each launch capture situation present with the alternative clock gating method of the present invention may be considered. The alternative clock gating method of the present invention assures that the proper clock adjustments are performed to slack calculations, including that the more pessimistic situation is considered by the timer whenever ambiguity exists.

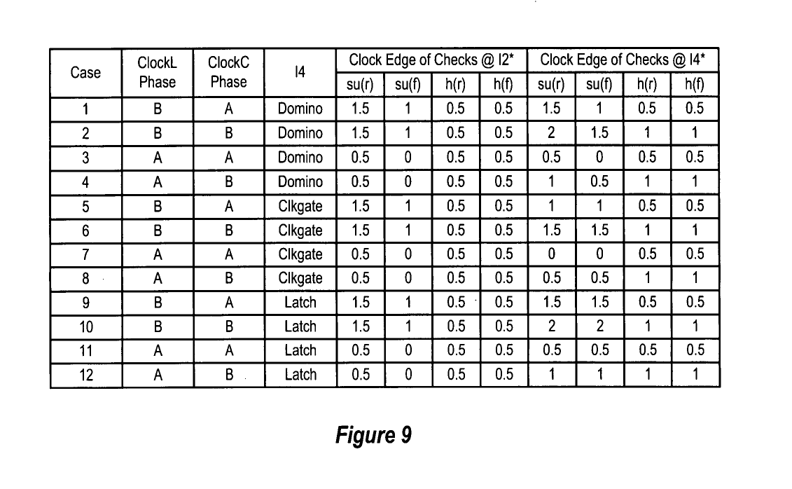

More specifically, the Table set forth in FIG. 9 shows the variety of launch and capture situations for the gated clock method. In this Table, the “net1” signal is either “A” or “B” phase data, the logic gate “I4” is a gated clock (and thus the inverter output “net3” is a data gate) or a latch or a domino gate, and the affiliated capture clock may be either “A” or “B” phase (see FIG. 8). In all substitutions for the logic element “I4,” the input signal “net3” is always a data signal and never a clock signal. Accordingly, the logic element “I2” is never considered a clock gate in this analysis.

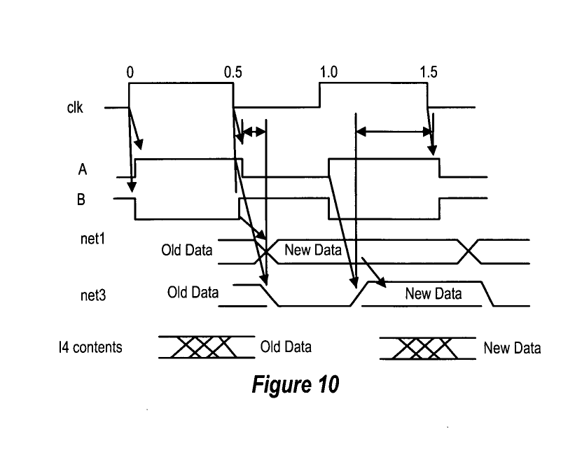

As an example to assist reading this Table, FIG. 10 shows a timing diagram where the “ClockL” and the “ClockC” nets of the FIG. 7 circuit design are connected to clock signals “B” and “A,” respectively, and logic element I4 is a latch. This example corresponds to Case 9 in the Table. First consider the checks that are performed by the static timing engine 100 at logic gate I2. The latch I1 launches data as a result of the clock event at time 0.5, “B” rising. The data arrives at “net1” some delay later and is checked at logic element I2 in the manner described with reference to the method shown in FIG. 5, as an alternative check to the clock gate checks and propagations. The falling edge of “net1 ” is checked against the rising edge of “A” at the clock edge corresponding to time 1.0 and “net1” rising is checked against the “A” edge at time 1.5. For mintime or early mode timing, the hold times are checked at the first launch of the data to ensure prior old data is not affected; this hold time check occurs at the clock edge corresponding to time 0.5.

Next consider the checks at latch I4. The data of “net3” is reset by “A” at time 0.5 and is able to take on new data after the clock's 1.0 edge. This is the data that must be latched by the falling clock edge corresponding to time 1.5. So both data rise and fall setup edges are referenced to the clock time of 1.5. Again, the hold time reference occurs at the first event the timer sees which affects the old data, and that happens at time 0.5.

In cases 1 through 4 of the Table, the I4 falling data setup check corresponds to a footed domino gate whereas if I4 were footless, then the reference edge should pull in by half a clock cycle to meet crowbar current avoidance. This renders case 3 to be a substantially impossible case to meet.

Accordingly, if the gate level tool identifies a logic block having both clock and data signals as inputs and a data signal as an output, the checks and propagations of a near-domino scenario works well, including consideration of node type traversal through the gate blocks as described. When designing the near domino element model, tests should be performed to assure the slack calculations are correct for all combinations of launch and capture elements for the tool to be a reliable aid to the design teams.

Other Embodiments

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, the above-discussed embodiments include modules that perform certain tasks. The modules discussed herein may include hardware modules or software modules. The hardware modules may be implemented within application specific circuitry or via some form of programmable logic device. The software modules may include script, batch, or other executable files. The modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

1. A method of modeling a combinatorial gate comprising:
providing a data signal input at the combinatorial gate;
providing a clock signal input at the combinatorial gate; and,
propagating the clock signal as an output signal when the output of the combinatorial gate corresponds to the clock signal; and,
propagating the data signal as an output when the output of the combinatorial gate corresponds to the data signal, the propagating the data signal modeling a near domino function.

2. The method of claim 1 wherein:
the near domino function is propagated based upon performing a reverse traversal function on a circuit design containing the combinatorial gate.

3. The method of claim 1 wherein:
the near domino function includes causing a later arriving edge of the data signal to cause the output signal to respond.

4. The method of claim 1 wherein:
the data signal includes a single edge per clock period; and,
when providing the near domino function, the single edge is propagated through the combinatorial gate.

5. The method of claim 1 wherein:
the clock signal includes two edges per clock period; and,
when propagating the clock signal, the two edges are propagated through the combinatorial gate.

6. A method of determining how to model a combinatorial gate where the combinatorial gate receives a data signal and a clock signal comprising:
performing a reverse traversal function on a circuit containing the combinatorial gate,
modeling an output of the combinatorial gate as the clock signal when an input to a next element of the circuit is a clock; and,
modeling the output of the combinatorial gate as a data signal when an input to a next element of the circuit is a data signal.

7. The method of claim 6 wherein:
the modeling the output of the combinatorial gate as a data signal includes a near domino function.

8. The method of claim 7 wherein:
the near domino function includes causing a later arriving edge of the data signal to cause the output signal to respond.

9. The method of claim 7 wherein:
the data signal includes a single edge per clock period; and,
when providing the near domino function, the single edge is propagated through the combinatorial gate.

10. The method of claim 7 wherein:
the clock signal includes two edges per clock period; and,
when propagating the clock signal, the two edges are propagated through the combinatorial gate.

11. A method of modeling a combinatorial gate within a static timing analysis comprising:
receiving a data signal at the combinatorial gate;
receiving a clock signal at the combinatorial gate; and,
providing an output corresponding to the clock signal when the output of the combinatorial gate corresponds to the clock signal; and,
providing an output having a near domino function when the output of the combinatorial gate corresponds to the data signal.

12. The method of claim 11 wherein:
the near domino function is provided based upon performing a reverse traversal function on a circuit design containing the combinatorial gate.

13. The method of claim 11 wherein:
the near domino function includes causing a later arriving edge of the data signal to cause the output signal to respond.

14. The method of claim 11 wherein:
the data signal includes a single edge per clock period; and,
when providing the near domino function, the single edge is propagated through the combinatorial gate.

15. The method of claim 11 wherein:
the clock signal includes two edges per clock period; and,
when providing the clock signal as the output, the two edges are propagated through the combinatorial gate.

16. A static timing engine comprising:
a data model, the data model including a combinational block determinator module, the combinational block determinator module including
means for performing a reverse traversal function on a circuit containing the combinatorial gate, and
a timing engine portion coupled to the data model, the timing engine portion including
means for modeling an output of the combinatorial gate as a clock signal when an input to a next element of the circuit is clock input; and,
means for modeling the output of the combinatorial gate as a data signal when an input to a next element of the circuit is a data input.

17. The static timing engine of claim 16 wherein:
the means for modeling the output of the combinatorial gate as a data signal includes means for modeling a near domino function.

18. The static timing engine of claim 17 wherein:
the near domino function includes causing a later arriving edge of the data signal to cause the output signal to respond.

19. The static timing engine of claim 17 wherein:
the data signal includes a single edge per clock period; and,
when providing the near domino function, the single edge is propagated through the combinatorial gate.

20. The static timing engine of claim 17 wherein:
the clock signal includes two edges per clock period; and,
when propagating the clock signal, the two edges are propagated through the combinatorial gate.
